(19) United States
(12) Patent Application Publication
(10) Pub. No.: US 2007/0115519 A1
(43) Pub. Date: May 24, 2007

(54) Holographic device with magnification correction

(75) Inventor: Coen Liedenbaum, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Phillips Electronics N.V.

(21) Appl. No.: 10/581,646

(22) PCT Filed: Nov. 26, 2004
(86) PCT No.: PCT/IB04/03905

§ 371 Date: Jun. 5, 2006

(30) Foreign Application Priority Data
Dec. 8, 2003 (EP) 03078840.0
Jul. 28, 2004 (EP) 0300488.6

(51) Int. Cl. G03H 1/00

(52) U.S. Cl. 359/1

(57) ABSTRACT

The invention relates a to an optical holographic device for reading out a data page recorded in a holographic medium (106). The device comprises means for receiving the holographic medium, means for imaging the data page and means (114) for detecting the imaged data page. It also comprises, between the receiving means and the detecting means, an electro-optical system (200, 300, 400) which magnification can be changed by application of a voltage between electrodes.

### FIELD OF THE INVENTION

The present invention relates to an optical holographic device for reading out a data page recorded in a holographic medium.

### BACKGROUND OF THE INVENTION

An optical device capable of recording on and reading from a holographic medium is known from H. J. Coufal, D. Psaltis, G. T. Sincerbox (Eds.), ‘Holographic data storage’, Springer series in optical sciences, (2000). FIG. 1 shows such an optical device using phase conjugate read out. This optical device comprises a radiation source 100, a collimator 101, a first beam splitter 102, a spatial light modulator 103, a second beam splitter 104, a lens 105, a first deflector 107, a first telescope 108, a first mirror 109, a half wave plate 110, a second mirror 111, a second deflector 112, a second telescope 113 and a detector 114. The optical device is intended to record in and read data from a holographic medium 106.

During recording of a data page in the holographic medium, half of the radiation beam generated by the radiation source 100 is sent towards the spatial light modulator 103 by means of the first beam splitter 102. This portion of the radiation beam is called the signal beam. Half of the radiation beam generated by the radiation source 100 is deflected towards the telescope 108 by means of the first deflector 107. This portion of the radiation beam is called the reference beam. The signal beam is spatially modulated by means of the spatial light modulator 103. The spatial light modulator comprises transmissive areas and absorbent areas, which corresponds to zero and one data-bits of a data page to be recorded. After the signal beam has passed through the spatial light modulator 103, it carries the signal to be recorded in the holographic medium 106, i.e. the data page to be recorded. The signal beam is then focused on the holographic medium 106 by means of the lens 105.

The reference beam is also focused on the holographic medium 106 by means of the first telescope 108. The data page is thus recorded in the holographic medium 106, in the form of an interference pattern as a result of interference between the signal beam and the reference beam. Once a data page has been recorded in the holographic medium 106, another data page is recorded at a same location of the holographic medium 106. To this end, data corresponding to this data page are sent to the spatial light modulator 103. The first deflector 107 is rotated so that the angle of the reference signal with respect to the holographic medium 106 is modified. The first telescope 108 is used to keep the reference beam at the same position while rotating. An interference pattern is thus recorded with a different pattern at a same location of the holographic medium 106. This is called angle multiplexing. A same location of the holographic medium 106 where a plurality of data pages is recorded is called a book.

Alternatively, the wavelength of the radiation beam may be tuned in order to record different data pages in a same book. This is called wavelength multiplexing. Other kind of multiplexing, such as shift multiplexing, may also be used for recording data pages in the holographic medium 106.

During readout of a data page from the holographic medium 106, the spatial light modulator 103 is made completely absorbent, so that no portion of the beam can pass trough the spatial light modulator 103. The first deflector 107 is removed, such that the portion of the beam generated by the radiation source 100 that passes through the beam splitter 102 reaches the second deflector 112 via the first mirror 109, the half wave plate 110 and the second mirror 111. If angle multiplexing has been used for recording the data pages in the holographic medium 106, and a given data page is to be read out, the second deflector 112 is arranged in such a way that its angle with respect to the holographic medium 106 is the same as the angle that were used for recording this given hologram. The signal that is deflected by the second deflector 112 and focused in the holographic medium 106 by means of the second telescope 113 is thus the phase conjugate of the reference signal that were used for recording this given hologram. If for instance wavelength multiplexing has been used for recording the data pages in the holographic medium 106, and a given data page is to be read out, the same wavelength is used for reading this given data page.

The phase conjugate of the reference signal is then diffracted by the information pattern, which creates a reconstructed signal beam, which then reaches the detector 114 via the lens 105 and the second beam splitter 104. An imaged data page is thus created on the detector 114, and detected by said detector 114. The detector 114 comprises pixels, each pixel corresponding to a bit of the imaged data page. As a consequence the holographic device has to be designed in such a way that the imaged data page is carefully aligned with the detector 114, in such a way that a bit of the imaged data page impinges on the corresponding pixel of the detector 114. In other holographic devices, there are more pixels than bits of the imaged data page. For example, the holographic device is designed such that a bit impinges on four pixels.

As a consequence, such a holographic device cannot read a holographic medium for which it has not been designed. For example, if the holographic device has been designed in such a way that one pixel corresponds to one bit, and has been designed for reading out holographic mediums comprising data pages of 1500*1500 bits, it will not be able to read a holographic medium comprising data pages of 1000*1000 bits, because in this case one bit will be imaged on more than one pixel. This is a drawback, because a new holographic device with higher data capacity will not be able to read a holographic medium recorded with an older holographic device. The backwards compatibility is however a key issue when designing a new holographic device.

### SUMMARY OF THE INVENTION

It is an object of the invention to provide a holographic device which can read a plurality of different holographic media.

To this end, the invention proposes an optical holographic device for reading out a data page recorded in a holographic medium, said device comprising means for receiving said holographic medium, means for imaging said data page, means for detecting said imaged data page, and, located between said receiving means and said detecting means, an electro-optical system which magnification can be changed by application of a voltage between electrodes.

According to the invention, the magnification of the electro-optical system is modified as a function of the type of holographic medium inserted in the holographic device. For example, if a holographic medium with data pages of 1000*1000 pixels is inserted into a holographic device designed for reading holographic mediums with data pages comprising 1500*1500 pixels and designed in such a way that one bit impinges on one pixel, the magnification of the electro-optical system is set up in such a way that one bit of a data page is imaged on one pixel of the detector. In this case, a portion of the detector is not used for reading out the holographic medium.

The use of an electro-optical system is particularly advantageous, because it reduces the use of mechanical means, which are costly and bulky and which consume a relatively large electrical power.

The invention can also advantageously be used for modifying the magnification of an imaged data page, even if the holographic device has been designed for reading this data page. Actually, in holographic devices, there are often magnification errors, because the holographic medium is not always positioned at the place for which the holographic device has been designed, due to mechanical clearance or defects during manufacture of the holographic medium. Magnification errors result for example in a bit being imaged on more than one pixel, although the device has been designed in such a way that one bit impinges on one pixel, which give rise to errors in the detection of the data page. According to the invention, these magnification errors can be corrected.

It should be noted that patent U.S. Pat. No. 6,414,296 describes a holographic device which comprises an optical imaging system for steering an holographic data page. However, the magnification of this optical imaging system cannot be changed. Moreover, this optical imaging system makes use of mechanical means for steering the holographic data page.

It should also be noticed that patent application US 2003/0223101 describes a holographic device which comprises, between the holographic medium and the detector, a lens which focal length can be changed by application of a voltage. However, the lens described in this patent application does not have a variable magnification. This is used for compatibility with other optical storage mediums such as CD or DVDs.

Preferably, the electro-optical system comprises an electrowetting device. An electrowetting device comprises two different fluids separated by a meniscus, which shape can change by application of a suitable voltage between electrodes enclosing the liquids. The change of the shape of the meniscus is rapid and does not require a large quantity of power.

Advantageously, the electrowetting device comprises a fluid chamber, two different fluids separated by a meniscus of which an edge is constrained by the fluid chamber, a first electrowetting electrode arranged to act on a first side of the edge, a second electrowetting electrode arranged to act separately on a second side of the edge and voltage control means for providing a different voltage to said first and second electrowetting electrodes. Use of such an electrowetting device allows translation of the imaged data page with respect to the detector. This allows correcting for translational errors which occur in the holographic device, as a result of mechanical clearance. This thus improves the detection of a data page.

These and other aspects of the invention will be apparent from and will be elucidated with reference to the embodiments described hereinafter.

### BRIEF DESCRIPTION OF THE DRAWINGS

The invention will now be described in more detail by way of example with reference to the accompanying drawings, in which:

FIG. 1 shows a holographic device in accordance with the prior art;

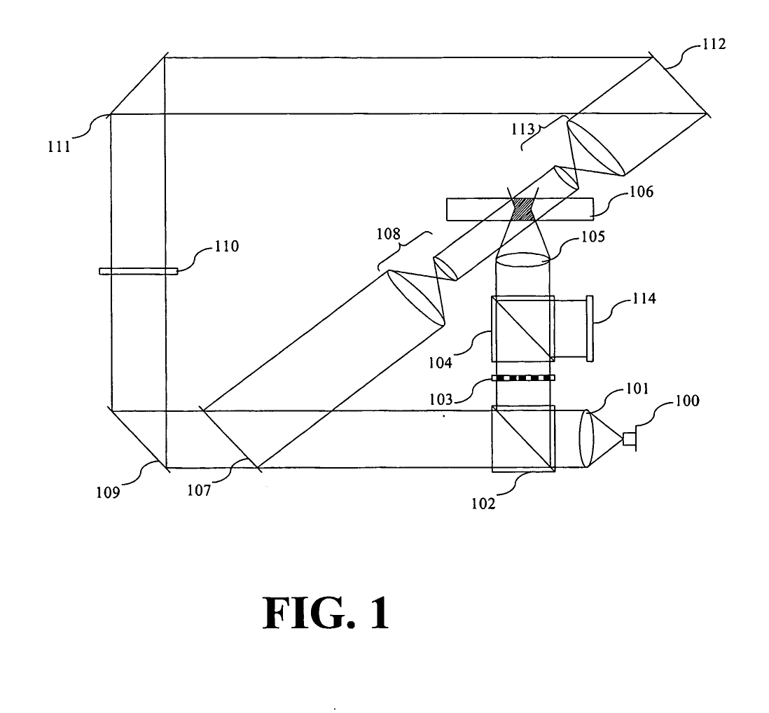

FIGS. 2a and 2b show the detection part of the holographic device of FIG. 1, modified in accordance with the invention;

FIGS. 3a and 3b show a holographic device in accordance with a preferred embodiment of the invention;

FIGS. 4a and 4b show a holographic device in accordance with an advantageous embodiment of the invention.

### DETAILED DESCRIPTION OF THE INVENTION

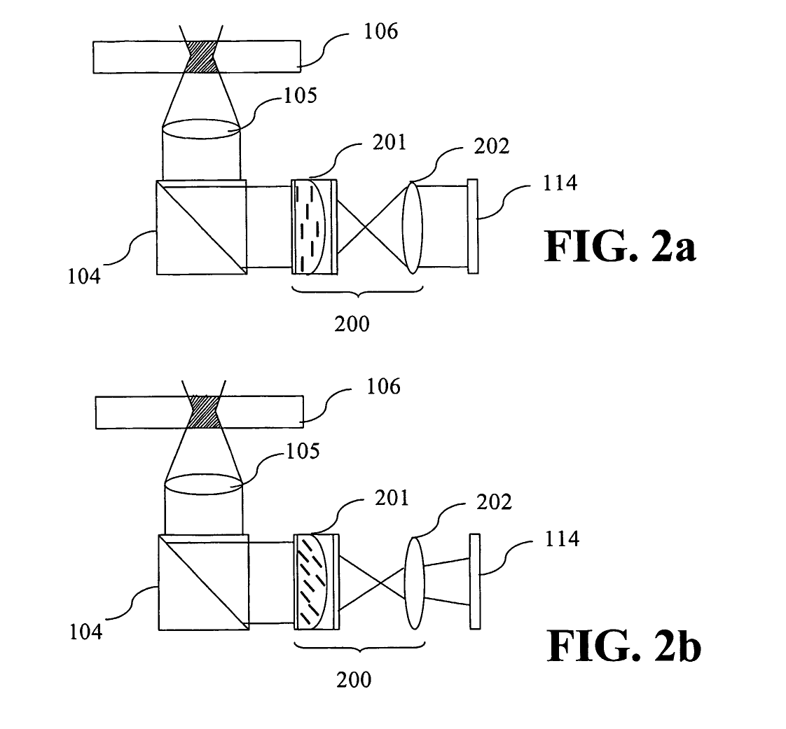

An holographic device in accordance with the invention is depicted in FIGS. 2a and 2b. It comprises the detector 114 for detecting an imaged data page, and an electro-optical system 200 which magnification can be changed by application of a voltage between electrodes. In this example, the electro-optical system 200 comprises a liquid crystal device 201 and a converging lens 202. The holographic device further comprises means for receiving the holographic medium 106, which are located at the location of said holographic medium 106. These receiving means are, for example, a table on which the recording medium can be put. A table such as those conventionally used in CD or DVD players can be used for example.

The liquid crystal device 201 comprises two electrodes enclosing a liquid crystal material and glass arranged in such a way that they are separated by a convex surface. The liquid crystal material has an ordinary refractive index nₒ and an extraordinary refractive index nₑ. The refractive index of the glass is chosen so as to be equal to nₒ. In the example of FIGS. 2a and 2b, the liquid crystal material is chosen in such a way that the liquid crystal molecules are oriented parallel to the electrodes when no voltage is applied between the electrodes. This can be achieved by use of suitable alignment layers in the liquid crystal device 201. In the example of FIGS. 2a and 2b, the polarization of the radiation beam coming from the second polarizing beam splitter 104 is parallel to the electrodes of the liquid crystal device 201.

In FIG. 2a, no voltage is applied between the electrodes of the liquid crystal device 201. As a consequence, the liquid crystal molecules are oriented parallel to the polarization of the radiation beam. The refractive index of the liquid crystal material is thus nₑ. As nₑ is superior to nₒ, the liquid crystal device 201 acts as a positive lens. The converging lens 202 is arranged on the path of the radiation beam in such a way that, in this configuration, the magnification of the electro-optical system 200 is 1.

In FIG. 2b, a voltage is applied between the electrodes of the liquid crystal device 201. As a consequence, the liquid crystal molecules turn towards a direction perpendicular to said electrodes, and the refractive index of the liquid crystal material decreases. The consequence is that the focal length of the liquid crystal device 201 increases. This is described, for example, in H. R. Stapert, J. Lub, E. J. K. Verstegen, B. M. I. van der Zande, and S. Stallinga, “Photo replicated anisotropic liquid crystalline lenses for aberration control and dual layer read out of optical disks”, Adv. Functional Materials vol. 13, pp. 732-738, 2003. As a consequence, the magnification of the electro-optical system 200 decreases. It should be noted that the quality of the beam may be improved by displacing the converging lens 202 in such a way that the focal point of the liquid crystal device 201 coincides with the focal point of the converging lens 202. In this case, a parallel beam impinges on the detector 114. In this case, use is made of mechanical means for displacing the converging lens 202. However, only one optical component needs to be displaced.

This can be used for compensating for a magnification error in the holographic device. Magnification errors can be detected, for example by means of alignment marks in the holographic medium 106, such as described in U.S. Pat. No. 5,838,650. If a magnification error is detected, the voltage between the electrodes of the liquid crystal device 201 is modified until the magnification error is cancelled. Although in the holographic device of FIGS. 2a and 2b, only a decrease of the magnification can be obtained by change of a voltage between the electrodes of the electro-optical system 200, it is possible to design an electro-optical system 200 which magnification can be increased and/or decreased. For example, if the liquid crystal material is chosen in such a way that the liquid crystal materials are oriented as in FIG. 2b when no voltage is applied, the application of a positive voltage decreases the magnification whereas the application of a negative voltage increases the magnification.

The electro-optical system 200 may also be used for compatibility purposes. If a data page comprising 1000*1000 bits has to be imaged on a detector comprising 1500*1500 pixels, and the holographic device is designed in such a way that one pixel corresponds to one bit, then the magnification has to be inferior to 1, because the area of a bit of the data page is larger than the area of a pixel of the detector. The magnification that has to be applied may be detected by means of a magnification error detection system, such as a system using alignment marks. Alternatively, the number of bits of a data page may be recorded as a data in the holographic medium 106, and detected by the detector 114. Depending on this number of bits and the number of pixels of the detector, the holographic device determines which magnification should be applied, and then which voltage should be applied. These data may be stored in a look-up table.

It should be noted that another liquid crystal device may be used instead of the converging lens 202. The two liquid crystal devices can be separated, or can be part of a same and one electro-optical element. For example, the two liquid crystal devices can have a common electrode. Use of two liquid crystal devices avoids use of any mechanical means, because the focal length of the two liquid crystal devices can be changed independently.

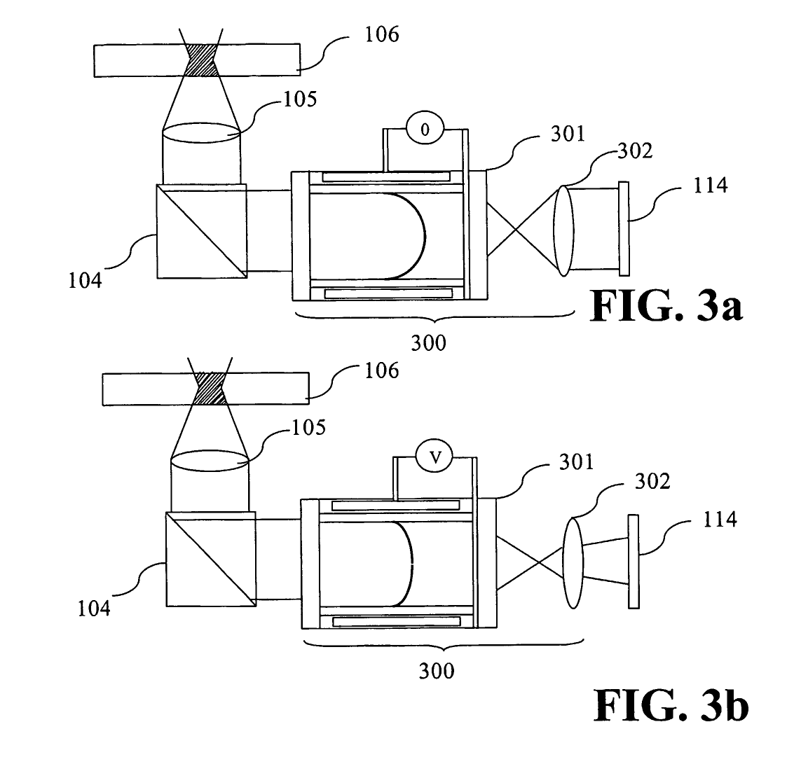

An holographic device in accordance with a preferred embodiment of the invention is depicted in FIGS. 3a and 3b. This holographic device comprises the same elements as the holographic device of FIGS. 2a and 2b, except that the electro-optical system 200 is replaced by an electro-optical system 300 comprising an electrowetting device 301 and a converging lens 302. An electrowetting device comprises a fluid chamber and two different fluids separated by a meniscus of which an edge is constrained by the fluid chamber. Application of a voltage to electrodes in the fluid chamber causes the meniscus to become more concave or convex, depending on the applied voltage. Electrowetting devices are well known to those skilled in the art. For example, such electrowetting devices are described in patent application WO99/18456.

In the example of FIG. 3a, no voltage is applied between the electrodes of the electrowetting device 301. The meniscus has a convex shape, which depends on the nature of the two fluids in the fluid chamber. In this example, the refractive indices of the two fluids are chosen in such a way that the electrowetting device 301 acts as a positive lens when no voltage is applied. In FIG. 3b, a voltage is applied between the electrodes of the electrowetting device 301. As a consequence, the meniscus becomes less convex and the electrowetting device 301 accordingly becomes less converging. Hence, the magnification of the electro-optical system 300 is reduced. As noted in the description of FIG. 2a, the converging lens 302 may be displaced in order to improve the quality of the beam on the detector 114.

It should be noted that the converging lens 302 may be replaced by another electrowetting device. In this case, the two electrowetting devices may be part of a same and one electro-optical element. For example, the zoom lenses described in patent application WO2004/038480 can be used as electro-optical system 300. Alternatively, the electro-optical system 300 may comprise an electrowetting device and a liquid crystal device such as described in FIGS. 2a and 2b. The focal length of these devices can be changed independently, such that the magnification of the electro-optical system 300 can be changed without use of mechanical means.

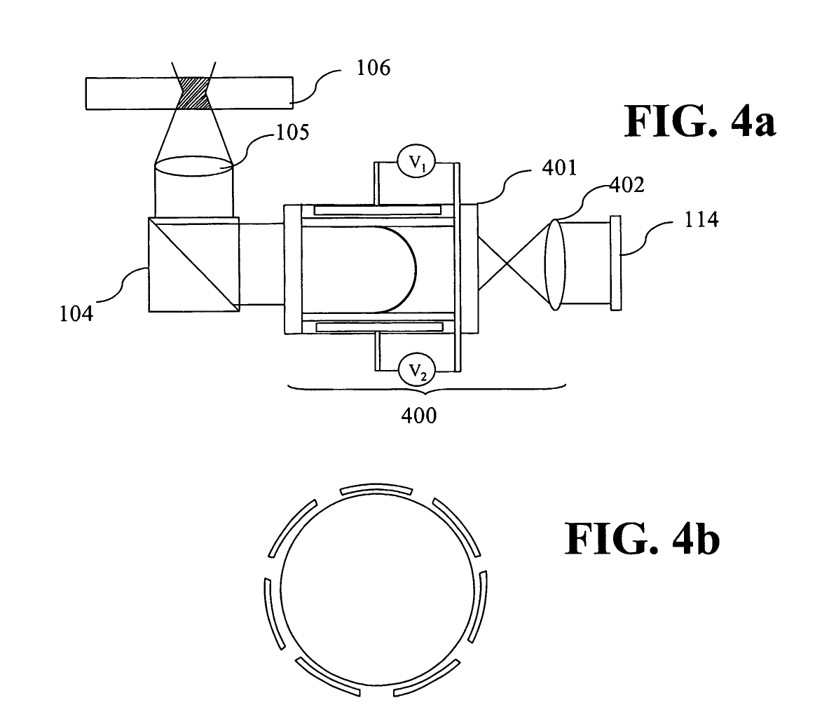

An holographic device in accordance with an advantageous embodiment of the invention is depicted in FIGS. 4a and 4b. This holographic device comprises the same elements as the holographic device of FIGS. 3a and 3b, except that the electro-optical system 300 is replaced by an electro-optical system 400 comprising a segmented electrowetting device 401 and a converging lens 402. FIG. 4b is a cross sectional view of the segmented electrowetting device 401. The segmented electrowetting device 401 comprises a plurality of electrodes. Different voltages may be applied between a given electrodes and a common electrode, such as V₁ and V₂ as represented in FIG. 4a. The segmented electrowetting device 401 thus comprises voltage control means for providing a different voltage to a first electrowetting electrode arranged to act on a first side of the edge and to a second electrowetting electrode arranged to act separately on a second side of the edge. Such a segmented electrowetting device 401 is known from patent application WO2004/051323.

As explained in this publication, application of different voltages to the first and second electrodes leads to an angular deflection of the radiation beam passing through the segmented electrowetting device 401. It is thus possible to correct for translational errors in the holographic device. If the bits of the imaged data page are shifted with respect to the pixels of the detector 114, suitable voltages are applied to electrodes of the segmented electrowetting device 401 until the imaged data page is carefully aligned with the detector 114. This avoids use of mechanical means to translate, for example, the detector 114 in order to correct for translational errors.

Any reference sign in the following claims should not be construed as limiting the claim. It will be obvious that the use of the verb “to comprise” and its conjugations does not exclude the presence of any other elements besides those defined in any claim. The word “a” or “an” preceding an element does not exclude the presence of a plurality of such elements.

1. An optical holographic device for reading out a data page recorded in a holographic medium (106), said device comprising means for receiving said holographic medium, means for imaging said data page, means (114) for detecting said imaged data page, and, located between said receiving means and said detecting means, an electro-optical system (200, 300, 400) which magnification can be changed by application of a voltage between electrodes.

2. An optical holographic device as claimed in claim 1, wherein the electro-optical system (300) comprises an electrowetting device (301).

3. An optical holographic device as claimed in claim 2, wherein said electrowetting device (401) comprises a fluid chamber, two different fluids separated by a meniscus of which an edge is constrained by the fluid chamber, a first electrowetting electrode arranged to act on a first side of the edge, a second electrowetting electrode arranged to act separately on a second side of the edge and voltage control means for providing a different voltage to said first and second electrowetting electrodes.

4. An optical holographic device as claimed in claim 1, wherein the electro-optical system (200) comprises a liquid crystal device (201).
